(19) United States
(12) Patent Application Publication
(10) Pub. No.: US 2018/0343195 A1
(43) Pub. Date: Nov. 29, 2018

(54) DATA COMMUNICATION SYSTEM

(71) Applicant: Vivint Solar, Inc., Lehi, UT (US)

(72) Inventors: Willard S. MacDonald, Sebastopol, CA (US); Roger L. Jungerman, Petaluma, CA (US)

(21) Appl. No.: 15/989,889

(22) Filed: May 25, 2018

Related U.S. Application Data
(60) Provisional application No. 62/511,067, filed on May 25, 2017.

(51) Int. Cl. H04L 12/707; H04L 12/703; H04L 29/08; H04L 12/28; H02J 3/38; H02S 99/00

(52) U.S. Cl. CPC H04L 45/22; H04L 45/28; H04L 67/12; H02S 40/32; H02J 3/383; H02S 99/00; H04L 12/2898

(57) ABSTRACT

A system including a gateway is provided. A system may include a router and a gateway. The gateway may be configured for coupling to a remote server via a first communication path including the router and a second communication path including a cellular network. The communication system may further include one or more solar system components communicatively coupled to the gateway.

### CROSS-REFERENCE TO RELATED APPLICATION

A claim for benefit of priority to the May 25, 2017 filing date of the U.S. Patent Provisional Application No. 62/511,067, titled DATA COMMUNICATION SYSTEM (the '067 Provisional Application), is hereby made pursuant to 35 U.S.C. § 119(e). The entire disclosure of the '067 Provisional Application is hereby incorporated herein.

### TECHNICAL FIELD

This disclosure relates generally to data communication, more specifically, to transmitting data from a system to a remote server via at least one of a plurality of communication paths.

### BACKGROUND OF RELATED ART

A residential solar power system may transmit data (e.g., related to solar production and/or installed solar power equipment) to a remote device (e.g., a remote server) via a communication path.

The subject matter claimed herein is not limited to embodiments that solve any disadvantages or that operate only in environments such as those described above. Rather, this background is only provided to illustrate one example technology area where some embodiments described herein may be practiced.

### BRIEF SUMMARY

In one specific embodiment, a system may include a gateway. The gateway may be configured for coupling to a remote server via a first communication path including a router. The gateway may further be configured for coupling to the remote server via a second communication path including a cellular network. The system may also include one or more solar system components communicatively coupled to the gateway. According to various embodiments, first data, which may include high priority data, and second data, which may include low priority data, may be transmitted via the first communication path. Further, in response to the first communication path being unavailable, the first data, which may include high-priority data, may be transmitted via the second communication path.

In another specific embodiment, a system may include a gateway device. The gateway device may include at least one input port for receiving a power input. The gateway device may further include a power sensor coupled to the at least one input port and configured for sensing a power status of the power input. The gateway device may also include an energy storage device coupled to the at least one input port and configured to store energy. Further, the gateway device may include a communication device coupled to the power sensor and configured to transmit a message indicative of the power status of the power input to a remote server.

According to other embodiments, the present disclosure includes methods for transmitting data from a system to a remote server. Various embodiments of such a method may include transmitting first data from a gateway to a remote server via a first communication path including a router. The method may also include transmitting second data from the gateway to the remote server via the first communication path. Further, the method may include transmitting the first data from the gateway to the remote server via a second communication path including a cellular network in response to the first communication path being unavailable.

Other aspects, as well as features and advantages of various aspects, of the present disclosure will become apparent to those of skill in the art through consideration of the ensuing description, the accompanying drawings and the appended claims.

### BRIEF DESCRIPTION OF THE DRAWINGS

FIG. 1 depicts an example system including a data source, a router, and a server;

FIG. 2 depicts an example system including a data source, a cellular network, and a server;

FIG. 3 illustrates an example system including a data source, a gateway, a router, a cellular network, and a server;

FIG. 4A illustrates the example system of FIG. 3 utilizing a first communication path;

FIG. 4B illustrates the example system of FIG. 3 utilizing a second communication path;

FIG. 5 depicts an example gateway;

FIG. 6 depicts another example gateway;

FIG. 7A is a block diagram of an example solar power system;

FIG. 7B is a block diagram of another example solar power system; and

FIG. 8 depicts an example flow diagram of a method of transmitting data from a system to a remote server.

### DETAILED DESCRIPTION

Various embodiments disclosed herein relate to data communication and more specifically to data communication between a system (e.g., a solar power system) and a remote device, such as a remote server (e.g., a cloud server).

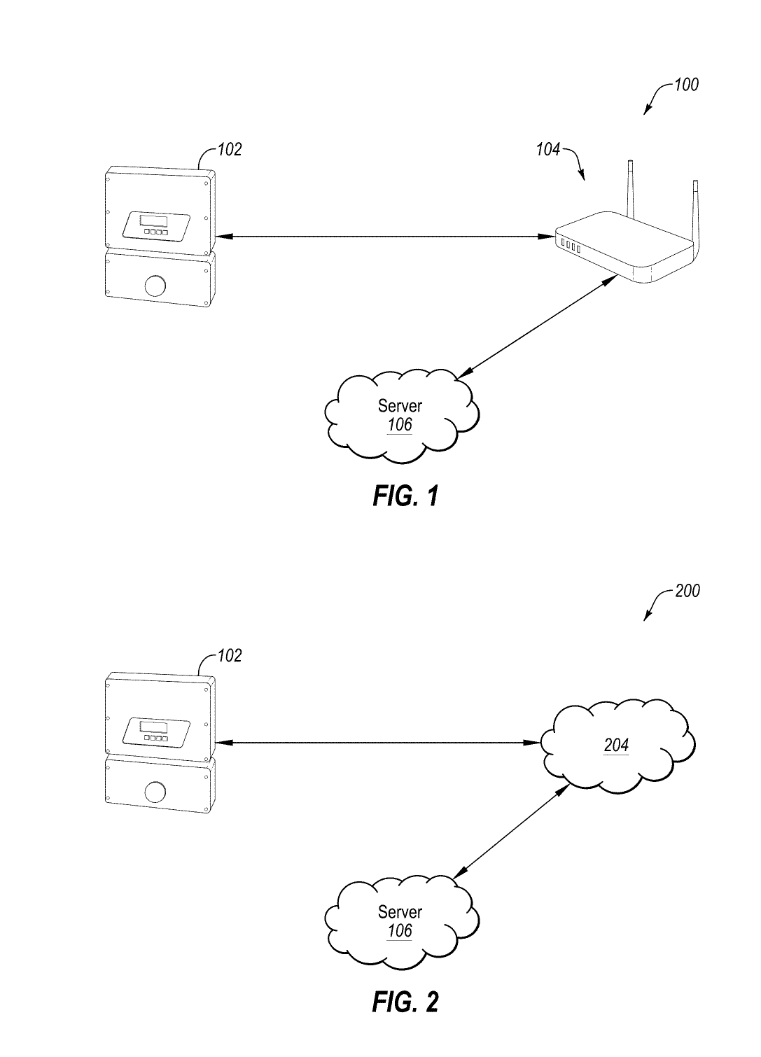

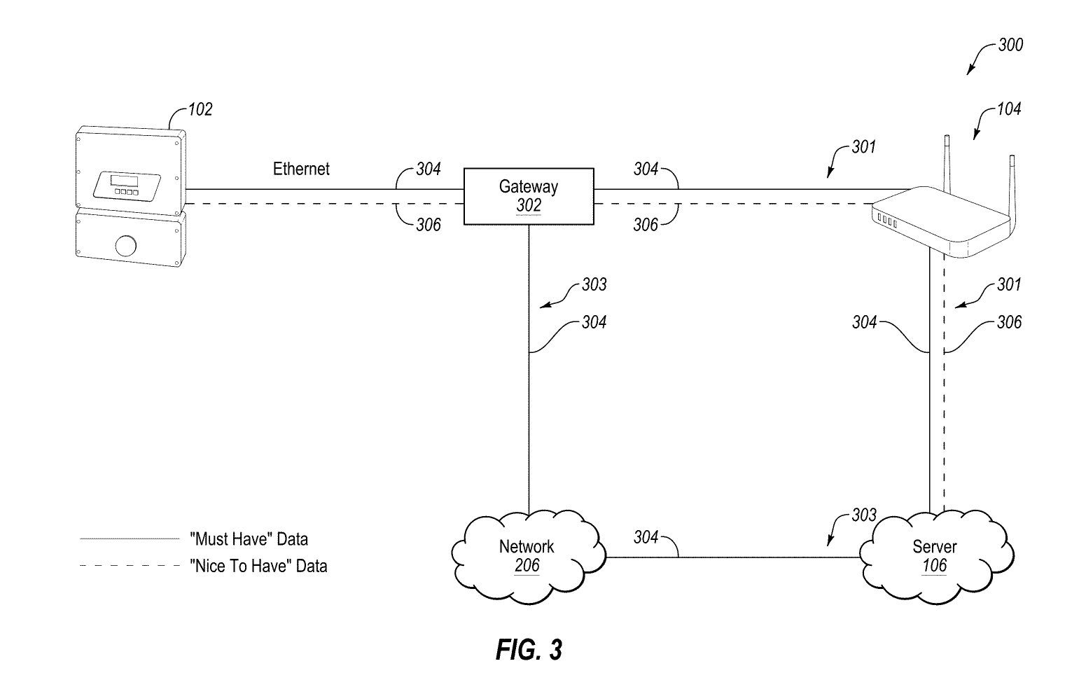

FIG. 1 depicts an example system 100 including a data source 102, a router 104, and a server 106. For example, data source 102 may include one or more components of a residential solar power system, such as one or more solar panels, an inverter, a battery, a meter, etc. Further, router 104 may include, for example, a router at a residence (e.g., a home router) and server 106 may include a cloud server. For example, data source 102 and router 104 may communicate via Wifi, Zigbee, and/or a power line bridge (“PLB”). FIG. 2 depicts another example system 200 including data source 102, cellular network 204, and server 106.

A router, such as a router 104 of FIG. 1, may be a low cost means of backhauling data (e.g., solar energy data). However, routers may exhibit low reliability (e.g., 15-25% of solar installations connected to a home Wifi or router may be off-line at any given time). Further, as shown in FIG. 2, system 200 may backhaul data via cellular network 204. Although a cellular network may provide high reliability, cellular service is expensive, and the cost of cellular may increase as an amount of data transmitted increases.

Various embodiments disclosed herein may relate to a system including a gateway (also referred to herein as a “gateway device”) configured to utilize both a low cost communication path (e.g., including a router (e.g., a home router)) and a high reliability communication path (e.g., including a cellular network) for transmitting data to a remote device (e.g., a remote server, such as a cloud server) while decreasing costs and/or increasing communications up time and reliability.

Solar power systems (e.g., a fleet of solar power systems) may be monitored remotely for health and performance. However, monitoring one or more solar systems may be challenging when power is lost (e.g., due to either a grid failure or to an AC disconnect of a solar power system being opened) because it may be unclear whether the solar power system is malfunctioning, a gateway associated with the solar power system is malfunctioning, or whether the solar power system is powered down. If power is not available to a gateway device associated with a solar power system, it may be impossible to know the status of the solar power system. Accordingly, some embodiments of the present disclosure relate to tracking when power is lost and/or restored to a solar power system and/or a communications gateway associated with the solar power system.

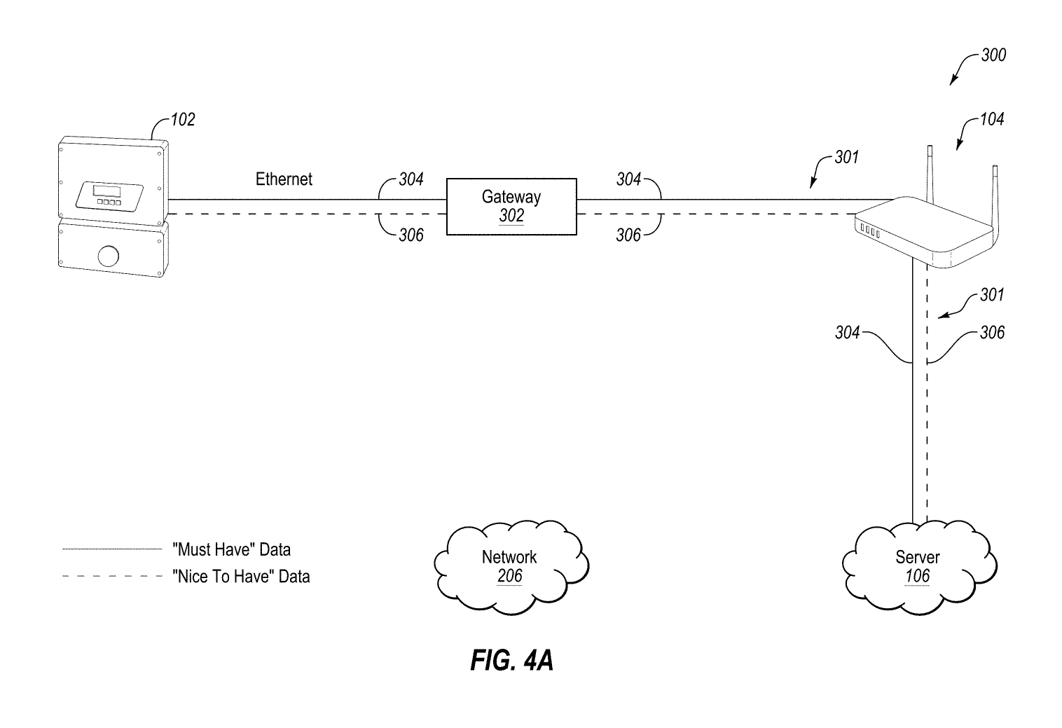

At least some of the disclosed embodiments may be used to backhaul data (e.g., in a cost effective manner) from a system (e.g., a residential energy system) that may include installed equipment (e.g., solar, storage, monitoring, or load control equipment). For example, FIG. 3 illustrates a system 300 including data source 102, a gateway 302, router 104, a network 206, and server 106. Network 206 may comprise a cellular network, a satellite network, or a combination thereof.

According to some embodiments, system 300 may include a communication path 301 from gateway 302 to server 106, and a communication path 303 from gateway 302 to server 106. According to various embodiments, communication path 301 includes router 104, and communication path 303 includes network 206. Communication path 301 may also be referred to herein as “first communication path,” a “primary path,” a “communication channel,” a “low-cost path,” a “high-bandwidth path,” or a “low-reliability path.” Further, communication path 303 may also be referred to herein as a “second communication path,” a “communication channel,” a “high-reliability path,” or a “high-cost path.”

Data source 102 may include, for example, a system, such as a solar power system including one or more solar panels and/or solar system components (e.g., inverter, battery, meter, etc.) Data conveyed from data source 102 may be data related to solar production and/or installed solar power equipment of the solar power system.

In some embodiments, first data 304 (also referred to herein as “high priority data” or “must have data”) and second data 306 (also referred to herein as “low priority data” or “nice to have data”) may be transmitted to server 106 via router 104 (e.g., via communication path 301). More specifically, for example, first data 304 and second data 306 may be transmitted from gateway 302 to router 104 via, for example, a Wifi network (e.g., a home Wifi network). Further, first data 304 and second data 306 may be transmitted from router 104 to server 106 via, for example, a broadband connection.

According to some embodiments, high priority data (e.g., first data 304) may be transmitted (e.g., continuously) via a primary low-cost/high-bandwidth/low-reliability (“low cost”) path (e.g. via a home router) when available and via a secondary high-reliability/high-cost (“high reliability”) path (e.g., cellular or satellite) when the low cost path is unavailable (e.g., if the low cost path fails). Stated another way, in the event communication path 301 is unavailable, data 304 may be transmitted via communication path 303. In these and other embodiments wherein communication path 301 is unavailable, data 306 may not be transmitted to server 106.

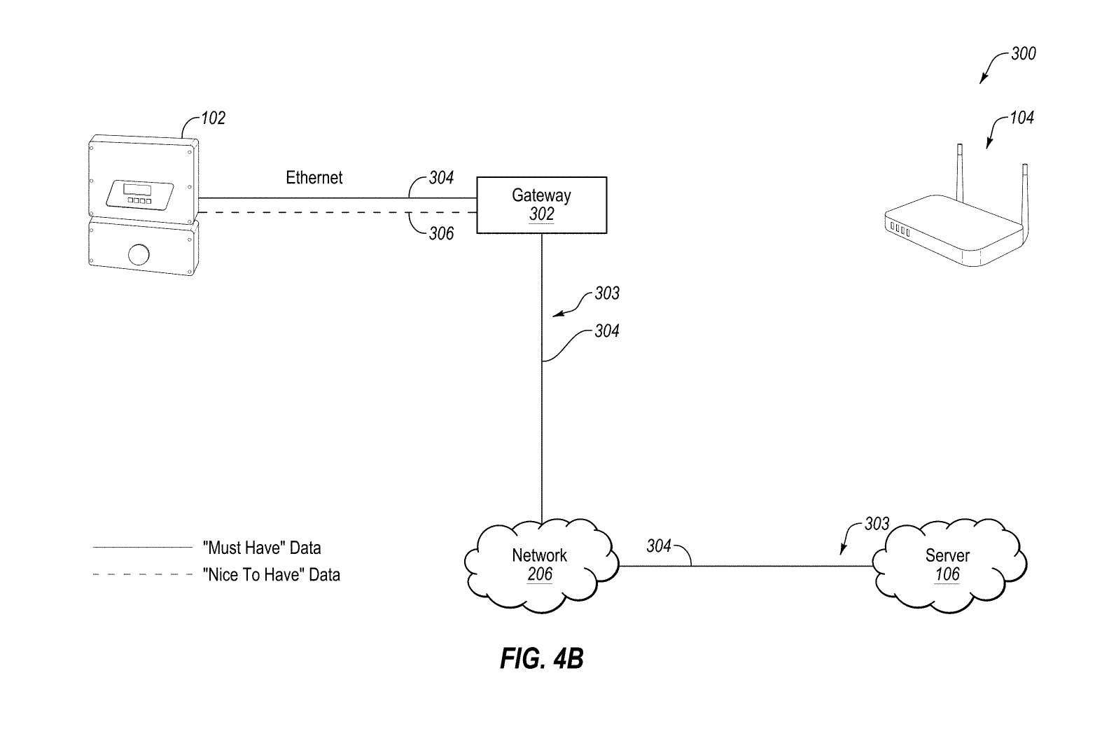

FIG. 4A illustrates an embodiment wherein data (e.g., high priority data 304 and low priority data 306) is transmitted via communication path 301 and FIG. 4B illustrates an embodiment wherein communication path 301 (see FIG. 4A) is unavailable and data (e.g., high priority data 304) is transmitted via communication path 303.

For example, high priority data may include, for example, daily billing data, system faults, and demand response (“DR”) data, and low priority data may include, for example, high resolution solar production (e.g., kWh per module every 5 minutes), high resolution home consumption data (e.g., kWh consumed by the home every second), and/or high resolution battery storage data (e.g., kWh stored or supplied by battery every second).

While a homeowner may pay for router 104 and Internet service, these costs may be a sunk cost for the homeowner. Accordingly, when system 300 utilizes communication path 301 (e.g., including router 104), there might not be an extra cost to a solar installer and/or home owner, thus making it an effectively zero cost.

As such, various embodiments of the disclosure may minimize an amount of data sent over a high cost connection (e.g., cellular channel). When cellular data plans are pooled (as is common with LTE cellular plans from cellular carriers), data that is unused by one cell SIM may be used by another. Thus, maximizing an amount of data sent via, for example, Wifi and/or a home router may reduce the overall total pooled data that must be purchased from the cellular carrier across a fleet of many solar installations.

In some embodiments wherein a high reliability path (e.g., communication path 303) includes a cellular network and when a low cost path (e.g., communication path 301) is currently in use, a cellular SIM card may be deactivated such that a data plan with a cellular carrier is not used, further reducing the total cost of data across the fleet. Typically (e.g., with cellular LTE IOT rate plans) if a cellular SIM card is de-activated during all times within a cellular billing cycle there is no charge in that billing cycle.

When the low cost path (e.g., communication path 301) is unusable, the SIM card may be activated and the high reliability channel (e.g., communication path 303) may be used. Subsequently, for example, a work order process may be initiated to re-establish the low cost channel (e.g., communication path 301). When the low cost path includes a home Wifi network, a common reason for loss of the path may be that an SSID and/or password for the Wifi network was changed (e.g., by the homeowner). The process of re-establishing the Wifi network may include providing a message to the homeowner via, for example, a smartphone app, email, text, or web page requesting the new Wifi credentials. These new credentials may be sent via the high reliability channel (e.g., communication path 303) to a gateway (e.g., gateway 302) to re-establish the Wifi connection. If re-establishing the low cost connection is unsuccessful, a phone call to the homeowner and/or a site visit may be required. Once the low cost channel is re-established, the low lost channel may again be used and the SIM card may be deactivated.

As noted above, various embodiments of the present disclosure include a communications gateway device (e.g., gateway 302) enabled to collect data (e.g., from installed solar power equipment (e.g., source 102)) (e.g. via Ethernet or RS485) and route or send the data to a remote device (e.g., server 106) selectively over a low cost channel (e.g., communication path 301) (e.g., including a Wifi network and a home router) or a high reliability channel (e.g., communication path 303) (e.g., including via a cellular network, a satellite network, or a combination thereof).

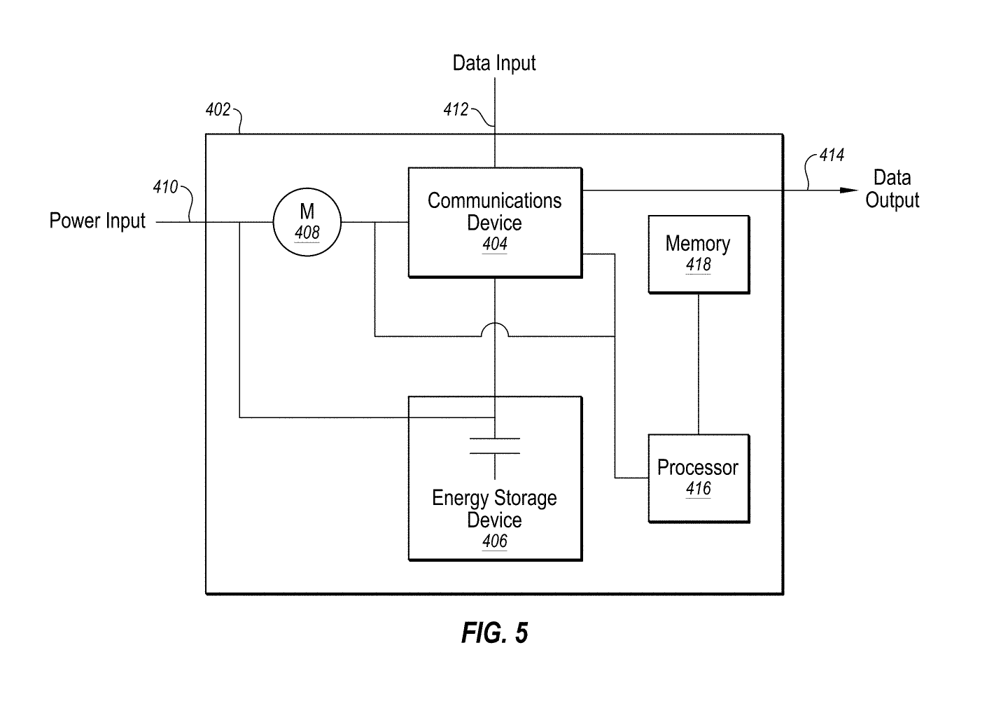

FIG. 5 depicts an example gateway 402, arranged in accordance with at least one embodiment disclosed herein. In this embodiment, gateway 402, which may include gateway 302 illustrated in FIG. 3, may include a communication device 404, an energy storage device 406, a power sensor 408, a power input 410, a data input 412, and a data output 414. Each of power input 410 and data input 412 may be coupled to a source, such as source 102 of FIG. 3. Data output 414 may be configured for transmitting data to a remote device (e.g., server 106 of FIG. 3) via, for example, communication path 301 and/or communication path 303 (see FIG. 3).

Energy storage device 406, which may include, for example, one or more energy storage elements, may be configured to receive and store energy received via power input 410. Power sensor 408 may be configured to sense a power status of power input 410 and/or a power status of gateway 402. More specifically, power sensor 408 may be configured to detect whether power provided to gateway 402 via power input 410 is lost. Further, power sensor 408 may be configured to detect if power is lost within gateway 402.

Gateway 402 may further include a processor 416 and a memory 418. In general, processor 416 may include any suitable special-purpose or general-purpose computer, computing entity, or processing device including various computer hardware or software modules and may be configured to execute instructions stored on any applicable computer-readable storage media. For example, processor 416 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 5, processor 416 may include any number of processors configured to perform, individually or collectively, any number of operations described in the present disclosure.

In some embodiments, processor 416 may interpret and/or execute program instructions and/or process data stored in memory 418. In some embodiments, program instructions loaded into memory 418, may be executed via processor 416.

Memory 418 may include computer-readable storage media for carrying or having computer-executable instructions or data structures stored thereon. Such computer-readable storage media may include any available media that may be accessed by a general-purpose or special-purpose computer, such as processor 416. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause processor 416 to perform a certain operation or group of operations.

In some embodiments, memory 418 may store data associated with a solar power system. For example, memory 418 may store data related to solar production and/or installed solar power equipment.

Communication device 404 may include any device, system, component, or collection of components configured to allow or facilitate communication between gateway 402 and another electronic device. For example, communication device 404 may include, without limitation, a modem, a network card (wireless or wired), an infrared communication device, an optical communication device, a wireless communication device (such as an antenna), and/or chipset (such as a Bluetooth device, an 802.6 device (e.g. Metropolitan Area Network (MAN)), a Wi-Fi device, a WiMAX device, cellular communication facilities, etc.), and/or the like. Communication device 404 may permit data to be exchanged with any network such as a cellular network, a Wi-Fi network, a MAN, an optical network, etc., to name a few examples, and/or any other devices described in the present disclosure, including remote devices.

Modifications, additions, or omissions may be made to FIG. 5 without departing from the scope of the present disclosure. For example, gateway 402 may include more or fewer elements than those illustrated and described in the present disclosure.

In some embodiments, gateway 402 may be configured to transmit a message (e.g., a “powering down” message) via data output 414 to a remote device (e.g., server 106) upon power to gateway 402 and/or an associated system (e.g., solar power system) being lost. For example, power may be lost if a grid goes down or if a breaker or AC disconnect supplying power to gateway 402 is opened.

It may be helpful for remotely troubleshooting a solar power system to determine whether power was lost to an inverter and/or a communications system. In response to detecting loss of power (e.g., via power sensor 408), a powering down message may be transmitted to a remote device (e.g., cloud server 106; see FIG. 1). For example, processor 416 may, in response to loss of power, cause a powering down message to be sent via data output 414 to the remote server.

In some embodiments, energy storage device 406 may provide sufficient energy for gateway 402 to operate without external power long enough to send the powering down message before being depleted. An amount of time needed to send the message may, for example, be approximately 5-10 seconds and the energy used by gateway 402 may be relatively small. Hence, energy storage device 406 may be relatively small, and may include, for example, a capacitor, ultra-capacitor, small battery, etc.

In some embodiments, a message (e.g., powering down message) may include a code that signifies that gateway 402 has lost power. The message may further include a date and time stamp and an identification for identifying which system in a fleet is powering down. When power is restored to gateway 402, another message (e.g., a “power restored” message) may be sent to the remote device (e.g., server 106). Upon power being restored, energy storage device 406 may be recharged (e.g., in preparation for a subsequent power outage).

In some embodiments, a gateway, which may include a power meter, a processor, memory, and/or an energy storage device, may be part of a solar inverter. In these embodiments, a cost of a system may be reduced. For example, in some embodiments, the inverter may include the energy storage device (e.g., energy storage device 406) and/or the power sensor (e.g., power sensor 408). One limitation of including a gateway within an inverter is that when an AC disconnect is opened (e.g., in between the time of solar system installation and permission to operate (“PTO”)) power to the gateway may be lost. In some embodiments, a gateway (e.g., gateway 402) may be configured to generate a powering down and/or power restored message, which may allow a system operator to remotely determine that the AC disconnect was opened and when the AC disconnect is closed again. This may be useful for regulatory or policy reasons requiring a system to be off before permission to operate (PTO) and may provide an audit trail.

Often a solar system is installed and tested and then turned off (e.g., via an AC disconnect or breaker) while waiting for inspections and interconnection permission or PTO. Once inspection and PTO are received the AC disconnect or breaker may be closed. A technician may be sent to the home to do this, but this may be costly. A homeowner may be asked to do it, but this is unreliable and inconvenient for the homeowner. Thus, it may be desirable to provision a solar system remotely. This may include bringing the system on line remotely. While it may be possible to turn an inverter off and/or on remotely, it is challenging to know that the inverter was verifiably off prior to being turned on. A system may not be communicating, which could indicate that the system is indeed off, but it could also be that the system is not communicating because something in the communication channel failed (e.g., the home router). The present disclosure may provide a reliable communications channel with redundancy and may further provide a means for notifying (e.g., a remote operator) when the system transitions from on to off or off to on (e.g., loses power or has power restored).

According to some embodiments, a gateway may receive power from different power sources, each of which may have different advantages and disadvantages in terms of reliability.

In at least one example, a gateway may receive power from an inverter (e.g., when a gateway is within the inverter). This may reduce costs, however, the gateway may lose power when, for example, an AC disconnect or solar breaker is opened. In another example, a gateway may receive power from a grid side of an AC disconnect. However, if and when the grid goes down, power to the gateway may be lost. In yet another example, a gateway may receive power from a backup (or critical load) circuit that comes from an energy storage system. However, this power source may be lost when the inverter is turned off (e.g., prior to a permission to operate (PTO) or if an inverter or battery fault condition occurs or when the storage has been depleted). In yet another example, a gateway may receive power directly from a DC photovoltaic (PV) circuit. This may have an advantage of receiving power whenever the sun is illuminating one or more solar panels (e.g., possibly independent of whether the inverter is on or not), but may not receive power at other times (e.g., at night). In yet another example, a gateway may receive power directly from a DC battery circuit. In one embodiment, a gateway may be powered from one of the power sources described above. For example, when installed solar power equipment includes grid backup capability, the gateway may be powered from the backup (or critical load) circuit. Hence, in the event the grid goes down, the gateway may continue to receive power.

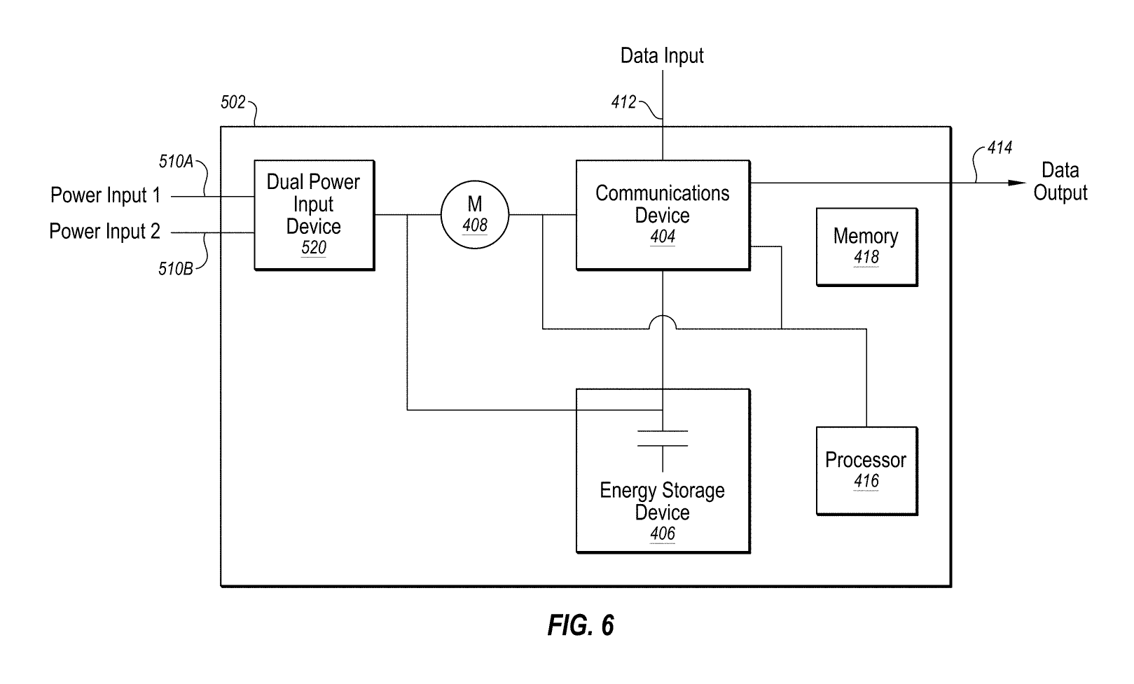

In other embodiments, a gateway may be powered from more than one power source. For example, with reference to FIG. 6, a gateway 502, which may include gateway 302 of FIG. 3, includes a dual power input device 520 configured to receive a first power input 510A and a second power input 510B. For example, first power input 510A may be coupled to an AC breaker (e.g., in the home's breaker panel that is different from a solar breaker). This may enable gateway 502 to maintain power when an AC disconnect or solar breaker is opened. Further, for example, second power input 510B may be coupled to DC power provided from, for example, a solar power system. Thus, in the event that the grid goes down and power to first power input 510A is lost, second power input 510B may receive power whenever the sun is illuminating panels of the solar power system. If the grid is down for more than a day, second power input 510B may enable gateway 502 to power up for part of the day and send a daily status update to a remote server (e.g., cloud server 106 of FIG. 3).

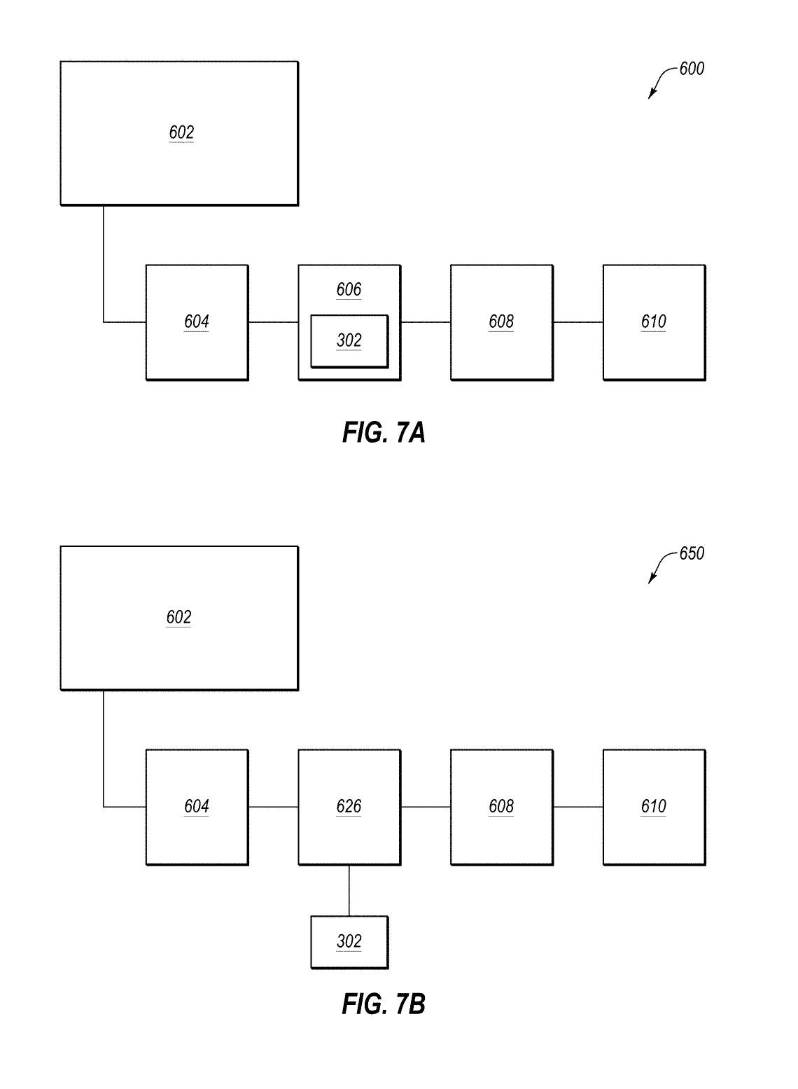

FIG. 7A is a block diagram of an example solar power system 600, arranged in accordance with at least one embodiment of the present disclosure. System 600 includes one or more solar panels 602, an (optional) DC disconnect 604, an inverter 606, an (optional) AC disconnect 608, and a breaker panel or utility panel 610. In this embodiment, inverter 606 includes gateway 302, as described herein.

FIG. 7B is a block diagram of another example solar power system 650, arranged in accordance with at least one embodiment of the present disclosure. System 600 includes one or more solar panels 602, optional DC disconnect 604, an inverter 626, optional AC disconnect 608, breaker or utility panel 610, and gateway 302. In this embodiment, inverter 626 is coupled to gateway 302.

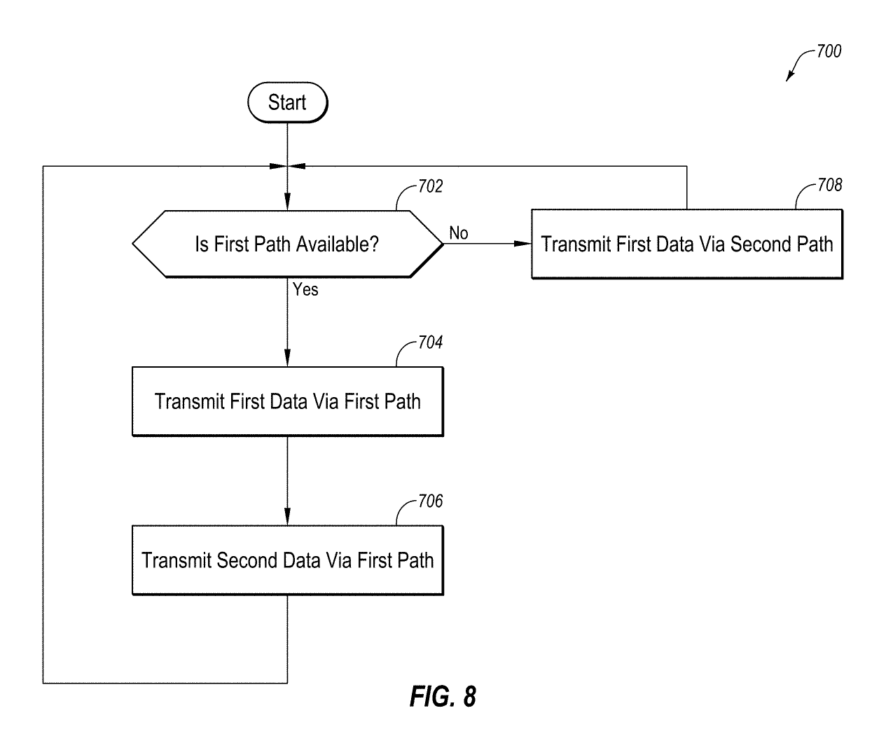

FIG. 8 shows an example flow diagram of a method 700 of transmitting data from a system (e.g., a solar power system) to a remote device (e.g., a remote server, such as a cloud server), arranged in accordance with at least one embodiment described herein. Although illustrated as discrete blocks, various blocks may be divided into additional blocks, combined into fewer blocks, or eliminated, depending on the desired implementation.

In some embodiments, method 700 may be performed by one or more systems and/or devices, such as system 300 and/or gateway 302 of FIG. 3. For instance, processor 416 (see FIG. 5 and/or FIG. 6) may be configured to execute computer instructions stored on memory 418 to perform functions and operations as represented by one or more of the blocks of method 700.

Method 700, which may be used to, for example, transmit data from a solar power system (e.g., a residential solar power system) to a remote server, may begin at block 702. At block 702, a determination may be made as to whether a first communication path is available. If the first communication path is available, method 700 may proceed to block 704.

At block 704, first data may be transmitted via the first communication path, and method 700 may proceed to block 706. For example, with reference to FIG. 3, first data, which may include high priority data, may be transmitted from gateway 302 to server 106 via communication path 301.

At block 706, second data may be transmitted via the first communication path, and method 700 may return to block 702. For example, with reference to FIG. 3, second data, which may include low priority data, may be transmitted from gateway 302 to server 106 via communication path 301.

At block 708, the first data may be transmitted via a second communication path, and method 700 may return to block 702. For example, with reference to FIG. 3, in response to failure and/or unavailability of communication path 301, the first data, which may include high priority data, may be transmitted from gateway 302 to server 106 via communication path 303.

Modifications, additions, or omissions may be made to method 700 without departing from the scope of the present disclosure. For example, the operations of method 700 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In the present disclosure, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

1. A system, comprising:
one or more solar system components;
a remote server; and
a gateway comprising:
a power input device configured to receive one or more power inputs from the one or more solar system components;
a power sensor coupled to the power input device and configured to sense a power status of the one or more power inputs;
a data input configured to receiving data from the one or more solar system components; and
at least one communication device configured to:
transmit high priority data and low priority data to the remote server via a first communication path including a router; and
transmit high priority data to the remote server via a second communication path including a cellular network in response to the first communication path being unavailable.

2. The system of claim 1, wherein the at least one communication device is further configured to transmit a message indicative of the power status to the remote server.

3. The system of claim 1, wherein the one or more solar system components comprise one or more of an inverter, a battery, and a meter.

4. The system of claim 1, wherein the high priority data comprises at least one of billing data, system fault data, and demand response data, and wherein the low priority data comprises at least one of high resolution solar production data, high resolution home consumption data, and high resolution battery storage data.

5. The system of claim 1, further comprising a residential solar system including the one or more solar system components, wherein the router comprises a residential router and the remote server comprises a cloud server.

6. The system of claim 1, wherein the gateway is further configured to:
communicate with the one or more solar system components via an Ethernet connection;
communicate with the router via a Wifi connection; and
communicate with the remote server via the second communication path via a cellular connection.

7. The system of claim 1, further comprising a solar inverter, wherein the solar inverter includes the gateway.

8. The system of claim 1, the gateway further comprising an energy storage device coupled to the power input device and configured to store energy.

9. The system of claim 1, wherein the power input device includes a dual power input device including a first power input coupled to an AC breaker and a second power input coupled to a DC power source of a solar power system including the one or more solar system components.

10. A method, comprising:
receiving data from one or more solar system components of a solar power system at a gateway;
transmitting high priority data of the received data and low priority data of the received data from the gateway to a remote server via a first communication path including a router; and
transmitting the high priority data from the gateway to the remote server via a second communication path including a cellular network in response to the first communication path being unavailable.

11. The method of claim 10, wherein receiving the data from the solar power system at the gateway comprises receiving the data from the one or more solar system components of the solar power system at the gateway via an Ethernet connection.

12. The method of claim 10, wherein transmitting the high priority data from the gateway to a remote server via a first communication path comprises:
transmitting the high priority data from the gateway to the router via a Wifi connection; and
transmitting the high priority data from the router to the remote server via a broadband connection.

13. The method of claim 10, further comprising:
receiving one or more power inputs at the gateway;
sensing a power status of the solar power system based on the one or more power inputs; and
transmitting a message indicative of the power status to the remote server.

14. The method of claim 13, further comprising storing energy from the one or more power inputs at an energy storage device within the gateway.

15. The method of claim 14, wherein transmitting the message comprises transmitting a powering down message while the gateway is powered via the stored energy.

16. The method of claim 13, wherein transmitting the message comprises transmitting one of a powering down message and a power restored message.

17. A residential solar power system, comprising:
a gateway device configured for coupling to a remote server via a first communication path including a router and a second communication path including a cellular network, the gateway device including:
at least one input port for receiving a power input;
a power sensor coupled to the at least one input port and configured for sensing a power status of the power input;
an energy storage device coupled to the at least one input port and configured to store energy; and
a communication device coupled to the power sensor and configured to transmit a message indicative of the power status to the remote server via one of the first communication path and the second communication path.

18. The residential solar power system of claim 17, further comprising at least one processor configured to receive the power status from the power sensor and convey the message indicative of the power status to the communication device.

19. The residential solar power system of claim 17, wherein the communication device is further configured to:
transmit high priority data and low priority data to the remote server via the first communication path; and
transmit high priority data to the remote server via the second communication path in response to the first communication path being unavailable.

20. The residential solar power system of claim 17, further comprising a solar inverter including the gateway device.
